(19) United States
(12) Patent Application Publication
(10) Pub. No.: US 2026/0117747 A1
(43) Pub. Date: Apr. 30, 2026

(54) TRANSMISSION MOUNTING FOR A WIND TURBINE

(71) Applicant: Flender GmbH, 46395 Bocholt (DE)

(72) Inventors: CHRISTIAN KÖNIG, Bocholt (DE); RALF GETTLER, Bocholt (DE)

(73) Assignee: Flender GmbH, 46395 Bocholt (DE)

(21) Appl. No.: 19/157,949

(22) PCT Filed: Feb. 28, 2024
(86) PCT No.: PCT/EP2024/055076

§ 371 Date: Aug. 19, 2025

(30) Foreign Application Priority Data
Mar. 6, 2023 (EP) 23160148.5

(51) Int. Cl. F03D 15/10; F03D 9/25; F03D 13/10; F03D 80/70

(52) U.S. Cl. CPC F03D 15/101; F03D 9/25; F03D 13/122; F03D 80/70; F05B 2220/706; F05B 2230/60

(57) ABSTRACT

A machine arrangement for rotary transmission of a drive power includes a housing element, a rolling-bearing arrangement including an inner bearing raceway, an outer bearing raceway, rolling bodes designed to roll on the inner and outer bearing raceways, and a bearing cover, and a rotation element held in the housing element via the rolling-bearing arrangement for rotation about an axis of rotation. The housing element has structure regions directed toward the rolling bodies. The inner and outer bearing raceways are formed by a material which is connected integrally to the structure regions respectively and which is applied additively to the structure regions. The bearing cover of the rolling-bearing arrangement is designed to include the structure region which forms the outer bearing raceway.

The invention relates to a machine arrangement for rotary transmission of a drive power, comprising a housing element, a rotation element and at least one rolling-bearing arrangement, wherein, via the at least one rolling-bearing arrangement, which has rolling bodies that roll on an inner and an outer bearing raceway, the rotation element is held in the housing element so as to be rotatable about an axis of rotation A_{D}.

The rotation element may be for example a shaft which transmits a torque or else a planet carrier which rotates in a transmission housing. A drive train which includes such components may be situated for example in a wind turbine in the force flow between a rotor and a generator. The drive train generally contains a planetary transmission for transmitting a drive torque from the rotor to the generator. Bearing arrangements of planet carriers in housings of such planetary transmissions are designed either with cylindrical-roller bearings or, recently, with tapered roller bearings. In particular on the torque-conducting side of the planet carrier, there is formed in the seat of the bearing ring a notch which weakens the planet carrier and limits the transmission of torque. This counters a continuous increase in the power density of such a drive train and of the installed components.

For the selection of the rolling bearing for the bearing arrangement, it is generally the case that not load-based and service-life-based dimensioning but measurement-based or geometrical dimensioning is decisive. The reason for this is that the diameter of the rotor-side rolling bearing has to be greater than the flange diameter of the planet carrier, which is driven by the rotor via the main shaft, in order to be able to fit the rolling bearing from the direction of the rotor. The same consideration applies to the generator-side rolling bearing and the possibility of fitting it.

The installed rolling bearings constitute a considerable cost factor for the transmissions. As a result of the need to integrate bearing seats for receiving the bearing rings into the planet carrier and the housing components, there are formed structural notches which, in particular in the case of the planet carrier, are known to be critical regions of high loading. In order to reduce the notch effects, large radii must be provided in the planet carrier, in particular on the torque-conducting side, in order to arrange the bearing seats for receiving the bearing rings. As a result of these radii, the necessary axial and radial installation space for the transmissions is increased.

DE 10 2013 012847 A1 presents a rotary drive with a worm transmission, for example for cranes. In this case, a rotatable rotary plate is held with respect to a base-side frame element via a rolling bearing arrangement. The rolling bodies are accommodated directly, without bearing shells, between the structure of the rotary plate and the structure of the frame element. US 6 588 119 B1 presents a bearing arrangement for a machine element, in which bearing arrangement the rolling bodies roll on inserted bearing rings in each case. A description is given of a setting device for setting a bearing load or a bearing clearance that, when attached to or inserted into the machine element, temporarily replaces the actual bearing cover together with the associated bearing shell in order to determine the required axial dimension of the bearing cover to be fitted.

Moreover, with a pairing of rolling bearings, the bearing preload or a bearing clearance is set via at least one of the bearing outer rings. A high-quality and expensive bearing steel is used for the bearing rings, wherein the use of relatively thin bearing rings allows the cost disadvantage to be compensated at least partially.

Both the soft structures and the thin-walled bearing rings increasingly lead to the phenomenon of bearing-ring migration, in particular of the outer bearing rings, occurring with respect to the surrounding structure. As a remedial measure, provision may be made for example of a form-fitting rotation-prevention means. However, here too, with a further increase in power density, a form-fitting rotation-prevention means no longer being able to absorb the increasing migration forces, and the increasingly more thin-walled bearing rings no longer offering material, for example to receive a feather-key groove, to a sufficient extent, can be expected. Consequently, there is a need, in particular in the region of the bearing rings, to adequately make provision for the increasing power density and in this case to take account in particular of the phenomenon of bearing-ring migration, specifically while maintaining a practicable possibility of bearing adjustment.

It is the object of the invention to provide measures which, with continuous settability of the bearing, avoid bearing-ring migration.

The object is achieved by a machine arrangement having the features of claim 1. Preferred configurations, which may in each case individually or in combination represent an aspect of the invention, are specified in the dependent claims and the following description. If a feature is presented in combination with another feature, this serves only for simplified presentation of the invention and is in no way intended to mean that this feature cannot also be a refinement of the invention without the other feature.

One embodiment relates to a machine arrangement for rotary transmission of a drive power, comprising a housing element, a rotation element and at least one rolling-bearing arrangement, wherein, via the at least one rolling-bearing arrangement, which has rolling bodies that roll on an inner and an outer bearing raceway, the rotation element is held in the housing element so as to be rotatable about an axis of rotation A_{D}, wherein the housing element has respective structure regions directed toward the rolling bodies and the bearing raceways are formed by a material which is connected integrally to the respective structure region and the material is applied additively to the structure region (22),

wherein a bearing cover of the rolling-bearing arrangement comprises the structure region which forms the outer bearing raceway.

The term machine arrangement is to be understood broadly. Provision is made of a housing element which may be a housing cover, a connection flange, a torque-supporting component, a tube or tube-like component or the like. The housing element may be of multi-part design and it is not absolutely necessary for it to be arranged so as to be absolutely immovable with respect to a base; it may be arranged for example so as to be rotatable or pivotable with respect to a base. The rotation element may be for example a shaft, a hollow shaft, a cage-shaped and rotating drive element, for example drive flange, a planet carrier or the like. The rolling-bearing arrangement may be provided as an inclined bearing pairing which is fitted under a preload. The rolling-bearing arrangement may also be designed as a paired bearing for one-sided mounting. For the housing element and the rotation element, provision may also be made for these to be rotation elements which are nested one inside the other.

A structure region of the housing element or of the rotation element is to be understood as meaning at least one bearing region of the respective element. A structure region may comprise a region which has been added onto or into the structure of the housing element or of the rotation element by means of an additive manufacturing process. In the case of a housing element, a structure region may be for example a housing-wall region. If the housing element forms a housing bore, the bore wall surrounding the housing bore may be referred to as a structure region. In the case of a rotation element, if this is for example a shaft or a drive flange, the structure region is formed by a region via which the rotation element is held, received, mounted or guided with respect to the housing element.

A bearing raceway is the surface of a component on which, when use is made of rolling bodies, the latter directly roll. A bearing raceway thus comprises at least one rolling track on which rolling bodies are intended for rolling. The actual bearing raceway is kept very thin with respect to the component on or at which it is situated. In addition to the at least one rolling track, a bearing raceway also comprises a depth region which is situated below the surface of the rolling track and in which internal compressive stresses above a certain minimum magnitude prevail in an operating situation. In each of the configurations described here, at least one bearing raceway is an inherent constituent part of the structure region of the housing element or alternatively or additionally of the rotation element. The bearing raceway and the structure element are connected to one another in one piece and cannot be separated from one another in a non-destructive manner. It is not sufficient for the surface of the structure element to be hardened for example by case hardening or carburization, since although this leads to a different chemical composition than the basic structure, this does not lead to a different material connected to the structure element.

The fact that the bearing raceway is an inherent constituent part of a structure element of the housing element or of the rotation element compared with conventionally used bearing rings, means that a functional integration of the rolling properties, such as for example rolling strength, of a discrete rolling bearing, in particular of a discrete bearing ring, with the properties of the housing element or of the rotation element has taken place. This advantageously makes it possible to increase the power density, specifically as a consequence of the lower radial installation height and the lower weight due to the discrete bearing ring being dispensed with. It is moreover advantageous that the bearing cover comprises the structure region forming the outer bearing raceway and produced by additive manufacturing, so that the bearing arrangement, that is to say the bearing preload or the bearing clearance, can be set directly via the bearing cover. A further advantage is that it is no longer possible for bearing-ring migration to take place since the bearing raceways are an inherent constituent part of a structure region. Moreover, another result is a cost saving since only a reduced use of high-price bearing steel is required. Moreover, the number of working steps in the assembly is reduced since, for each bearing raceway, two fits are dispensed with and the assembly outlay for tight fits is dispensed with. The reduced number of working steps and fewer component interfaces, which in each individual case entail the risk of incorrectly designed or incorrectly produced bearing seats and bearing bores, results in a reduced risk of faults or risk of failure.

In a preferred configuration, the bearing cover is settable in terms of its axial position with respect to the housing element. This allows the bearing cover to be brought into an axial position with respect to the housing element in which the required or desired bearing preload or the bearing clearance is established. In a specifically preferred configuration, for setting the axial position of the bearing cover, the latter is reworked by way of cutting machining of the abutment surface with respect to the housing element. Alternatively, for setting the axial position of the bearing cover, provision may be made of at least one spacer element which is placed between the bearing cover and the housing element. Such a spacer element is expediently of round form and has a diameter in the same region as that of the rolling bearing for whose setting it serves. The spacer element may be of one-part or multi-part form. Preferably, the spacer element is configured as a spacer ring between an abutment shoulder of the bearing cover with integrated raceway and an abutment flange of the housing element.

The outer bearing raceway is formed by a material which is connected integrally to the structure region of the bearing cover. Here, a bearing raceway with increased rolling strength can be produced via the material in the structure region. In a specific configuration, provision is made for the material to be applied additively to the structure region. Material can be applied additively to the structure region for example by laser deposition welding, cold spraying and/or thermal spraying, It is in this case particularly preferable if a material with increased rolling strength is used. A material which is applied additively but nevertheless connected integrally to the structure region allows targeted adaptation of the bearing properties of the overall component to the respective requirements.

In a preferred embodiment in terms of production, the material applied to the structure region has undergone a material treatment which influences the surface hardness. By way of the material treatment, hardening takes place for example via locally active heat treatment. Hot rolling can also be carried out.

In a further preferred refinement, the bearing cover forms a circumferentially extending collar which projects between the housing element and the rolling bodies in the axial direction, wherein the outer bearing raceway is formed on the collar.

The object is moreover achieved by a drive train for a wind turbine for torque-transmitting connection of a rotor to a generator, comprising a main bearing unit, which has a bearing housing and a main shaft, and a transmission, which is driven via the main shaft, wherein the transmission at least indirectly drives the generator and has a housing element, which is in the form of a transmission housing, and at least one rotation element, which is in the form of a planet carrier, wherein the transmission housing, the at least one planet carrier and the rolling-bearing arrangement are in the form of a machine arrangement according to one of the above-described embodiments. In specifically possible configurations, the bearing cover of the rolling-bearing arrangement is arranged on that side of the transmission which is directed toward the rotor or on that side of the transmission which is directed toward the generator.

Likewise, the object is achieved by a wind turbine comprising a rotor flange with a rotor and a generator, wherein provision is made of a drive train which is held on a machine carrier and which connects the rotor flange to the generator, and the drive train is designed as described above.

The object is furthermore achieved by a method for setting the machine arrangement as described, in which, for setting the axial position of the bearing cover, an abutment surface of an abutment shoulder of the bearing cover with respect to the housing element is adapted by mechanical reworking during assembly. Provision may furthermore be made for setting the axial position of the bearing cover by inserting a spacer element between an abutment shoulder of the bearing cover and a housing flange of the housing element.

Below, the invention will be explained by way of example with reference to the appended drawings on the basis of preferred exemplary embodiments, wherein the features presented below may in each case individually or in combination represent an aspect of the invention. It is shown in:

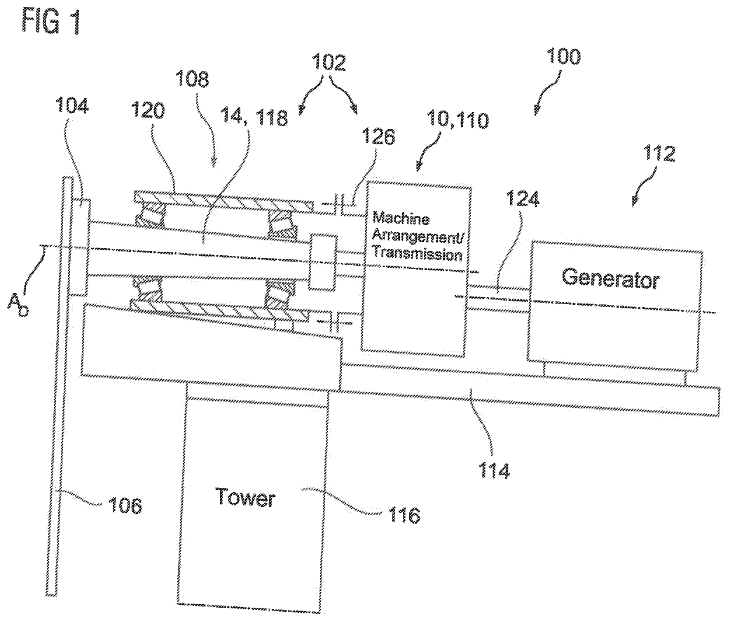

FIG. 1 a schematic illustration of a wind turbine in a first embodiment, and

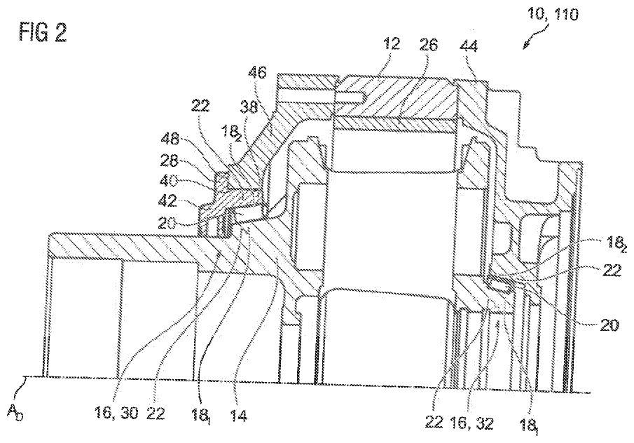

FIG. 2 a detail of a bearing configuration in a transmission for a wind turbine as per FIG. 1.

FIG. 1 shows in a schematic and not-to-scale illustration a wind turbine 100 in one possible embodiment. A fundamental element of the wind turbine 100 is a drive train 102, which in the present case structurally comprises a rotor flange 104 with a rotor 106, a main bearing unit 108, a transmission 110 and a generator 112. Via a machine carrier 114, at least the main bearing unit 108 and the generator 112 are supported via a tower 116 with respect to the ground (not Illustrated). The main bearing unit 108 comprises a main shaft 118 which is mounted via a rolling-bearing arrangement 16 so as to be rotatable about an axis of rotation D with respect to a bearing housing 120 of the main bearing unit 108. The rotor flange 104 is held on one end of the main shaft 118, and the rotor 106 is held on said rotor flange. The other end of the main shaft 118 is connected in terms of drive to the transmission 110 via a coupling 122 in order to introduce into the transmission 110 a drive torque or a drive power applied by the rotor 106. The transmission 110 may be designed as a planetary transmission with one or more planetary stages and comprise the machine arrangement 10. The transmission 110 is connected in terms of drive to the generator 112 via a generator shaft 124. The transmission 110 can deliver the drive power to the generator 112 via the generator shaft 124. The bearing housing 120 is connected to the transmission 110 via a flange 126. A reaction moment of the transmission 110 is supported with respect to the machine carrier 114 via the flange 126.

FIG. 2 shows a detail of the transmission 110, which is illustrated merely structurally in FIG. 1. The transmission 110 is designed as a planetary transmission, of which only one planetary stage is illustrated. The transmission 110 comprises a machine arrangement 10, which in turn comprises a housing element 12 and a rotation element 14 of the transmission 110. The housing element 12 may be of multi-part design; it may comprise for example a first and a second housing flange 44 and 46 connected thereto via screw connections. The rotation element 14 may be for example a planet carrier of the first planetary stage. The rotation element 14 is, via a rolling-bearing arrangement 16 with rolling bodies 20 rolling on bearing raceways 18, held in the housing element 12 so as to be rotatable about the axis of rotation A_{D}. The rotation element 14 designed as a planet carrier carries planet gears (not illustrated) which mesh radially outward with an inner toothing 26 and radially inward with a sun gear (likewise not illustrated). On the input side, that is to say on the left-hand side in the illustration shown, the rotation element 14 is in a drive connection with the main shaft 118 described in relation to FIG. 1.

FIG. 2 shows a configuration of the machine arrangement 10 in which the rolling-bearing arrangement 16 has a first rolling bearing 30 and a second rolling bearing 32. The rolling bearings 30, 32 are designed as tapered-roller bearings. Bearing raceways 18 of the rolling bearings 30, 32 are formed by a structure region 22, directed toward the respective rolling bodies 20, of the housing element 12 and of the rotation element 14. An inner bearing raceway 18₁ of the first rolling bearing 30 is formed by a structure region 22 of the rotation element 14, that is to say of the planet carrier. Moreover, an inner bearing raceway 18₁ of the second rolling bearing 32 is likewise formed by a structure region 22 of the rotation element 14, and an outer bearing raceway 18₁ of the rolling bearing 32 is formed by a structure region 22 of the housing element 12.

For the first rolling bearing 30, provision is made of a bearing cover 42 which comprises the outer bearing raceway 18₂. The bearing cover 42 forms a circumferentially extending collar 38 which projects between the housing element 46 and the rolling bodies 20 in the axial direction. The outer bearing raceway 18₂ is formed on the collar 38. Via the collar 38, the bearing cover of the first rolling bearing is seated axially in a centering seat 40 of the housing element 46. The axial positioning of the bearing cover 42 with respect to the housing element 46 allows a bearing preload or a bearing clearance of the rolling-bearing arrangement 16 to be set.

In the configuration of the machine arrangement 10 shown in FIG. 2, the bearing cover 42 is arranged on a side on which the drive power is absorbed. In the present case, this is the left-hand side in the illustration. Alternatively, the bearing cover 42 may also be arranged on that side of the machine arrangement 10 on which the drive power is delivered, which would be the right-hand side in the present Illustration. A separate illustration of this alternative arrangement of the bearing cover 42 is omitted. As a further alternative, it is possible for provision to be made of two bearing covers 42, of which one is arranged on the drive side and one is arranged on the output side.

For setting the axial position of the bearing cover 42, the bearing cover 42 is reworked at the abutment shoulder 28 by way of cutting machining of the abutment surface with respect to the housing element 46, whereby the axial position of the bearing-cover collar 38, into which the bearing raceway 18₂ is integrated, is set. For setting the axial position of the bearing cover 42, it is alternatively possible for provision to be made of at least one spacer element 48 which is seated between the bearing cover 42 and the housing element 46. The spacer element 48 may be configured as a spacer ring between an abutment shoulder 28 of the bearing cover 42 and an abutment flange 46 of the housing element.

The bearing raceways 18₁, 18₂ which are formed by the respective structure region 22 of the housing element 46 or of the rotation element 14 are formed by a material which is connected integrally to the structure region 22. The material is applied additively to the structure region 22. Provision may be made for the material applied to the structure region 22 to have undergone before start-up a material treatment which influences or increases the surface hardness. Provision may furthermore be made for the bearing raceways 18 to form one or more bearing rims.

### LIST OF REFERENCE SIGNS

10 Machine arrangement
12 Housing element
14 Rotation element
16 Rolling-bearing arrangement
18 Bearing raceway
20 Rolling body
22 Structure region
26 Inner toothing
28 Abutment shoulder
30 Rolling bearing
32 Rolling bearing
38 Collar
40 Centering seat
42 Bearing cover
44 Housing flange
46 Housing flange
48 Spacer element
100 Wind turbine
102 Drive train
104 Rotor flange
106 Multi-blade rotor
108 Main bearing unit
110 Transmission
112 Generator
114 Machine carrier
116 Tower What is claimed is:

11. (Canceled)

12. A machine arrangement for rotary transmission of a drive power, the machine arrangement comprising:
a housing element;
a rolling-bearing arrangement comprising an inner bearing raceway, an outer bearing raceway, rolling bodes designed to roll on the inner and outer bearing raceways, and a bearing cover; and
a rotation element held in the housing element via the rolling-bearing arrangement for rotation about an axis of rotation,
wherein the housing element has structure regions directed toward the rolling bodies, with the inner and outer bearing raceways being formed by a material which is connected integrally to the structure regions respectively and which is applied additively to the structure regions, and
wherein the bearing cover of the rolling-bearing arrangement is designed to include a corresponding one of the structure regions which forms the outer bearing raceway.

13. The machine arrangement of claim 12, wherein the bearing cover is designed such that an axial position of the bearing cover with respect to the housing element is adjustable.

14. The machine arrangement of claim 12, wherein the bearing cover is arranged on a side of the machine arrangement on which side a drive power is absorbed or on a side of the machine arrangement on which side the drive power is delivered.

15. The machine arrangement of claim 12, wherein the material applied to the structure regions has undergone a material treatment which influences a surface hardness.

16. The machine arrangement of claim 12, wherein the material has a rolling strength which is greater than a rolling strength of a base material of the structure regions.

17. The machine arrangement of claim 12, wherein the bearing cover comprises a circumferentially extending collar which projects between the housing element and the rolling bodies in an axial direction, with the outer bearing raceway being formed on the collar.

18. A drive train for a wind turbine for torque-transmitting connection of a rotor to a generator, the drive train comprising:
a main bearing unit comprising a bearing housing and a main shaft; and
a transmission driven via the main shaft and designed to at least indirectly drive the generator, said transmission comprising a housing element designed to form a transmission housing, a planet carrier designed to form a rotation element, and the machine arrangement of claim 12,
wherein the transmission housing, the planet carrier and the rolling-bearing arrangement form the machine arrangement.

19. The drive train of claim 18, wherein the bearing cover of the rolling-bearing arrangement is arranged on a side of the transmission which side is directed toward the rotor or on a side of the transmission which side is directed toward the generator.

20. A wind turbine, comprising:
a rotor flange comprising a rotor;
a generator; and
a drive train held on a machine carrier and connecting the rotor flange to the generator, said drive train comprising a main bearing unit comprising a bearing housing and a main shaft, and a transmission driven via the main shaft and designed to at least indirectly drive the generator, said transmission comprising a housing element designed to form a transmission housing, a planet carrier designed to form a rotation element, and the machine arrangement of claim 12, wherein the transmission housing, the planet carrier and the rolling-bearing arrangement form the machine arrangement.

21. A method for setting the machine arrangement of claim 12, the method comprising adapting an abutment surface of an abutment shoulder of the bearing cover with respect to the housing element by mechanical reworking during assembly for setting an axial position of the bearing cover.

22. The method of claim 21, further comprising inserting a spacer element between the abutment shoulder of the bearing cover and a housing flange of the housing element for setting the axial position.
